(19) United States
(12) Patent Application Publication
(10) Pub. No.: US 2012/0041785 A1
(43) Pub. Date: Feb. 16, 2012

(54) MEDICAL IMAGE PROCESSING DEVICE, MEDICAL IMAGE GROUPING METHOD, AND PROGRAM

(75) Inventors: Akinori Tsunomori, Tokyo (JP); Hitoshi Futamura, Tokyo (JP)

(73) Assignee: KONICA MINOLTA MEDICAL & GRAPHIC, INC., Tokyo (JP)

(21) Appl. No.: 13/262,826

(22) PCT Filed: Mar. 11, 2010
(86) PCT No.: PCT/JP2010/054081

§ 371 Date: Oct. 3, 2011

(30) Foreign Application Priority Data
Apr. 3, 2009 (JP) 2009-091128

(51) Int. Cl. G06Q 50/24

(52) U.S. Cl. 705/3

(57) ABSTRACT

A medical image processing apparatus includes a control unit for grouping input medical images from every same examination of a same patient by using accompanying information of the input medical images, and for saving the grouped medical images in a storage unit. When a medical image is newly input, the control unit collates accompanying information of the newly input medical image with the accompanying information of the grouped medical images to thereby judge whether the newly input medical image has been obtained by additional radiography or by re-radiography. The control unit regroups the newly input medical image and the grouped medical images from a same examination of a same patient by using the accompanying information, when the control unit judges that the newly input medical image has been obtained by either additional radiography or re-radiography.

### TECHNICAL FIELD

The present invention relates to a medical image processing device, a medical image grouping method, and a program.

### BACKGROUND ART

As one of the medical images obtained by examination radiography, a medical image (called a mammogram) of a breast as a radiography object can be cited. By a medical image processing apparatus called a computer-aided diagnosis/detection (CAD) apparatus, an obtained mammogram can be analyzed as an image, and a lesion candidate region having a possibility of being a lesion region, such as a growth and a microcalcification cluster, can be detected to be provided to a doctor as reference information.

In mammography, radiography is frequently performed to each of the breasts on both sides by changing the radiographing direction, and a plurality of sheets of mammograms is generally obtained at a time of examination radiography. At a time of medical examination, a doctor interprets the mammograms of the breasts on both the sides by comparing them to judge the existence of lesions or to ascertain the positions and the states of lesion regions. Moreover, also in the detection processing of a lesion candidate by a medical image processing apparatus, the detection of the lesion candidate is sometimes performed by comparing mammograms of the breast on both the sides.

It is accordingly preferable to treat the mammograms of the same examination of the same patient as one group. A system that automatically collects mammograms every same patient and every same subject to output the collected mammograms to a medical image processing apparatus was disclosed in the past (see, for example, Patent Document 1). By this system, input medical images can be collected every same patient and every same subject by the collation of information pertaining to the patients and the examinations, which information accompanies medical images, with a reference table, in which the number of the medical images input every patient is previously set.

### PRIOR ART DOCUMENT

### Patent Document

Patent Document 1: Japanese Patent Application Laid-Open Publication No. 2000-126163

### SUMMARY OF THE INVENTION

### Problems to be Solved by the Invention

However, there are some cases where grouping cannot successfully be performed in the system described in Patent Document 1 mentioned above.

For example, in examination radiography, radiography different from that scheduled at the beginning is frequently performed. The cases are as follows: the case in which radiography from only one direction has been scheduled at the beginning, but it is judged that diagnosis is difficult from the one direction and the radiography is changed to that from two directions at the time of the radiography to perform an additional piece of radiography; and the case in which something unsatisfactory is found after radiography by ascertainment of a medical image and re-radiography is performed. Because the medical image obtained by such unscheduled radiography is not registered in the reference table according to the system described in the aforesaid Patent Document 1, the medical image is collected to the group of another examination.

Moreover, if no more medical images are input owing to some network trouble although radiography itself is performed according to schedule, the system collects medical images, which have already been input, to output the corrected medical images to the medical image processing apparatus.

If the medical images essentially belonging to the same patient and the same examination are collected separately or are collected in a state of lacking some sheets of the medical images, some medical images to be used for left-and-right comparison would be lacking, and consequently the accuracy of the detection processing of a lesion candidate lowers. Moreover, also the detection results are output as different examinations, and a doctor cannot consequently perform efficient interpretation.

It is an object of the present invention to enable the grouping of a medical image obtained by radiography other than scheduled radiography.

### Means for Solving the Problems

According to an invention of claim 1, there is provided a medical image processing apparatus, comprising:

control means for grouping input medical images every same examination of a same patient by using accompanying information of the input medical images, and for saving the grouped medical images in storage means, wherein

when a medical image is newly input, the control means collates accompanying information of the newly input medical image with the accompanying information of the medical images the grouping of which has already been completed to thereby judge whether the newly input medical image has been obtained by either of additional radiography and re-radiography or not, and the control means regroups the newly input medical image and the medical images the grouping of which has already been completed every same examination of the same patient by using the accompanying information when the control means judges that the newly input medical image has been obtained by either of the additional radiography and the re-radiography.

According to an invention of claim 2, there is provided a medical image processing apparatus according to claim 1, wherein

when the accompanying information of the patient and the examination of the newly input medical image and that of the medical images the grouping of which has been completed agree with each other, respectively, and when the accompanying information of a radiographing region and a radiographing direction of the newly input medical image and that of the medical images the grouping of which has been completed do not agree with each other, respectively, then the control means judges that the newly input medical image is that of the additional radiography, and the control means classifies the newly input medical image into a group of the medical images each of which has the accompanying information of the patient and the examination that agree with that of the newly input medical image, respectively, and the grouping of which medical images has been completed, and thereby the control means regroups the group.

According to an invention of claim 3, there is provided a medical image processing apparatus according to claim 1 or 2, wherein

when the accompanying information of the patient, the examination, the radiographing region, and the radiographing direction of the newly input medical image and that of one of the medical images the grouping of which has been completed agree with each other, respectively, the control means judges the newly input medical image is that of the re-radiography, and the control means replaces the medical image the grouping of which has been completed and which has the accompanying information of the patient, the examination, the radiographing region, and the radiographing direction that agree with that of the newly input medical image with the newly input medical image, and the control means regroups the group.

According to an invention of claim 4, there is provided a medical image processing apparatus according to any one of claims 1-3, wherein

when the medical images are regrouped, the control means outputs the regrouped medical images to lesion candidate detecting means by the group.

According to an invention of claim 5, there is provided a grouping method of input medical images by means of a medical image processing apparatus, the method comprising the steps of:

grouping the input medical images every same examination of a same patient to save the grouped medical images in storage means by using accompanying information of the input medical images with control means;

collating accompanying information of a newly input medical image with the accompanying information of the medical images the grouping of which has already been completed to thereby judge whether the newly input medical image has been obtained by either of additional radiography and re-radiography or not with the control means when the medical image is newly input; and

regrouping the newly input medical image and the medical images the grouping of which has already been completed every same examination of the same patient by using the accompanying information when it is judged that the newly input medical image has been obtained by either of the additional radiography and the re-radiography with the control means.

According to an invention of claim 6, there is provided a program for making a computer function as a control means for

grouping input medical images every same examination of a same patient by using accompanying information of the input medical images to save the grouped medical images in storage means;

collating accompanying information of a newly input medical image with the accompanying information of the medical images the grouping of which has already been completed to thereby judge whether the newly input medical image has been obtained by either of additional radiography and re-radiography or not when the medical image is newly input; and

regrouping the newly input medical image and the medical images the grouping of which has already been completed every same examination of the same patient by using the accompanying information when it is judged that the newly input medical image has been obtained by either of the additional radiography and the re-radiography.

### Effects of the Invention

According to the present invention, even when an unscheduled medical image is input by additional radiography or re-radiography, the input medical image can be regrouped together with the medical images that have already been grouped. The medical images can correctly be grouped every same examination of the same patient by the regrouping, and the medical images can be used for the detection processing of a lesion candidate to improve the accuracy of the detection processing of the lesion candidate.

### BRIEF DESCRIPTION OF DRAWINGS

FIG. 1 is a diagram showing a medical image system;

FIG. 2 is a diagram showing a functional configuration of a medical image processing apparatus of the present embodiment;

FIG. 3 is a diagram showing an example of a grouping-completed DB;

FIG. 4 is a diagram showing an example of a new examination DB;

FIG. 5 is a flow chart showing grouping processing to be executed by the medical image processing apparatus;

FIG. 6 is a view showing a concrete example of the grouping in the case where an input medical image is judged to be that of a new examination;

FIG. 7 is a view showing a concrete example of the new examination where the grouping has been completed;

FIG. 8 is a view showing a concrete example of the grouping in the case where an input medical image is judged to be that of an additional examination;

FIG. 9 is a view showing a concrete example of the grouping in the case where an input medical image is judged to be that of a reexamination; and

FIG. 10 is a flow chart showing the grouping processing in the case of performing the grouping or the regrouping of a medical image group of the same patient and the same examination, wherein the medical image group has been input in a predetermined time.

### BEST MODE FOR CARRYING OUT THE INVENTION

In the following, an embodiment of the present invention will be described with reference to the accompanying drawings.

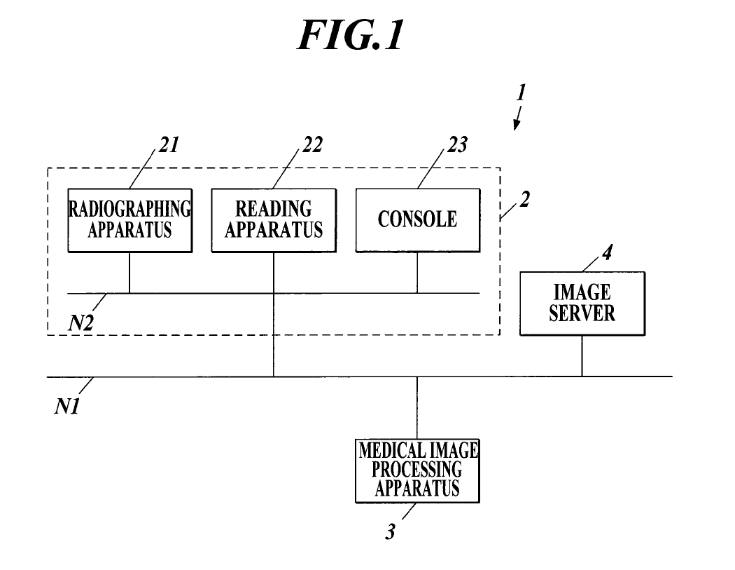

FIG. 1 shows the configuration of a medical image system 1 including a medical image processing apparatus 3 of the present embodiment. As shown in FIG. 1, the medical image system 1 includes a radiography system 2, the medical image processing apparatus 3, and an image server 4. The radiography system 2, the medical image processing apparatus 3, and the image server 4 are each connected to a network N1. The network N1 is, for example, a local area network (LAN) or the Internet, and uses Digital Imaging and Communication in Medicine (DICOM) as a communication standard thereof.

The radiography system 2 includes a radiographing apparatus 21, a reading apparatus 22, and a console 23. The radiographing apparatus 21, the reading apparatus 22, and the console 23 are each connected to a network N2. The network N2 is, for example, a LAN, and adopts DICOM similarly to the network N1.

The radiographing apparatus 21 is a radiographing apparatus for mammography. The radiographing apparatus 21 executes radiography processing in conformity with an instruction from the console 23.

The radiography system of the radiographing apparatus 21 may be either of a cassette system and a flat panel detector (FPD) system. The cassette system is a radiography system using a cassette incorporating a photostimulable phosphor plate therein, and requires a radiographer to change the cassette every time of radiography and load the reading apparatus 22 with the cassette to perform the read processing of a medical image.

The FPD system is a radiography system using a FPD including detectors, which are provided in a matrix for converting X-ray energy into electric signals. Because a medical image is generated by the FPD, no changes and no read processing with the reading apparatus 22 are necessary. In the case of the FPD system, the radiographing apparatus 21 transmits the medical images generated by the FPD to the console 23.

The reading apparatus 22 executes the read processing of a cassette to generate a medical image. In the read processing, the reading apparatus 22 radiates a laser light to a phosphor plate incorporated in the cassette and performs the photoelectric conversion of an excited light from the phosphor plate to generate an image signal. The reading apparatus 22 transmits the medical image obtained by performing A/D conversion and various kinds of signal processing to the image signal to the console 23.

The console 23 is a computer equipped with, for example, a control section, a display section, an operation section, a communication section, and a storage section. The console 23 is used for a radiography operation by a radiographer. The console 23 holds information of a patient who is an object of examination radiography and order information in which informations, such as a radiographing region and a radiographing direction, pertaining to the examination radiography is defined, and the console 23 displays a list of the order information before radiography. The radiographer can prepare the radiography in conformity with the order information selected from the list and can perform an operation of starting the radiography with the console 23. The radiographing apparatus 21 executes radiography processing, in conformity with an instruction from the console 23. After the radiography processing, a medical image is input from the reading apparatus 22, in the case of the cassette system, or from the radiographing apparatus 21, in the case of the FPD system, into the console 23.

The console 23 produces accompanying information of an input medical image on the basis of order information in conformity with the DICOM standard. The accompanying information includes information of the examination, such as an examination ID thereof and an examination name, besides the information of a patient, such as an image number, a patient ID, a full name, an age, a distinction of the sex, and a receipt number issued at the reception. Moreover, the accompanying information also includes information of radiography, such as the date and the time of radiography, the type of the radiographing apparatus (for example, mammography, computed radiography (CR), magnetic resonance imaging (MRI), computed tomography (CT)), the radiographing region, the radiographing direction, and the existence of a contrast medium. The image number is identification information attached for individually identifying a medical image.

The console 23 outputs a medical image accompanied by the accompanying information to the medical image processing apparatus 3 and the image server 4.

The medical image processing apparatus 3 executes the detection processing of a lesion candidate to a medical image input from the console 23 to detect the region of the lesion candidate included in the medical image. The information of the detection result is transmitted to the image server 4.

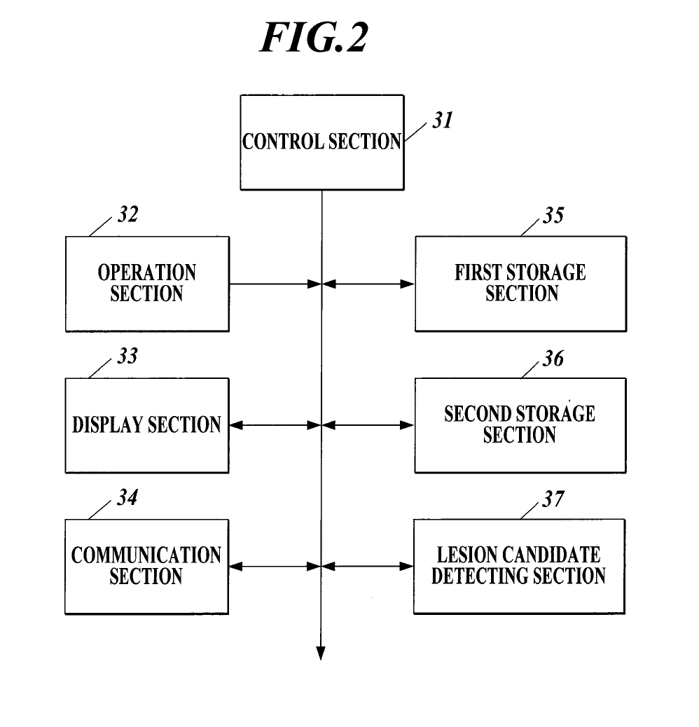

FIG. 2 is a diagram showing the functional configuration of the medical image processing apparatus 3.

As shown in FIG. 2, the medical image processing apparatus 3 is composed of a control section 31, an operation section 32, a display section 33, a communication section 34, a first storage section 35, a second storage section 36, and a lesion candidate detecting section 37.

The control section 31 is a control means equipped with a central processing unit (CPU) and a random access memory (RAM). The control section 31 executes various pieces of processing in cooperation with the programs stored in the first storage section 35. In the processing, the control section 31 performs various operations to perform the integrated control of each section of the medical image processing apparatus 3.

For example, in after-mentioned grouping processing, the control section 31 uses the accompanying information of input medical images to perform the grouping of the input medical images every same examination of the same patient and to save the grouped input medical images into the second storage section 36. When a medical image is newly input, the control section 31 collates the accompanying information of the newly input medical image with that of the medical images the grouping of which has already been completed, and the control section 31 thereby judges whether or not the input medical image has been obtained by either of additional radiography and re-radiography. When the control section 31 judges that the input medical image has been obtained by either of the additional radiography and the re-radiography, the control section 31 regroups the input medical image and the medical images the grouping of which has been completed every same examination of the same patient by using the accompanying information.

The operation section 32 is equipped with a keyboard and a mouse and generates an operation signal according to their operations to output the generated operation signal to the control section 31. A touch panel may be used as the operation section 32.

The display section 33 is equipped with a display and displays an operation screen and a medical image in conformity with the display control by the control section 31.

The communication section 34 is equipped with a communications interface and performs communication with an external apparatus on the networks N1 and N2. For example, the communication section 34 receives a medical image from the console 23 and transmits the information of a detection result of a lesion candidate to the image server 4.

The first storage section 35 stores programs, and files and data that are necessary for the execution of the programs. For example, a hard disk can be used as the first storage section 35.

The second storage section 36 is a storage means for temporarily saving a medical image input into the medical image processing apparatus 3. For example, a RAM can be used as the second storage section 36. The second storage section 36 stores a data base (DB) of the medical images saved in the second storage section 36 and can manage the medical images saved by the DB. The DB is updated by the control section 31 every saving of a medical image.

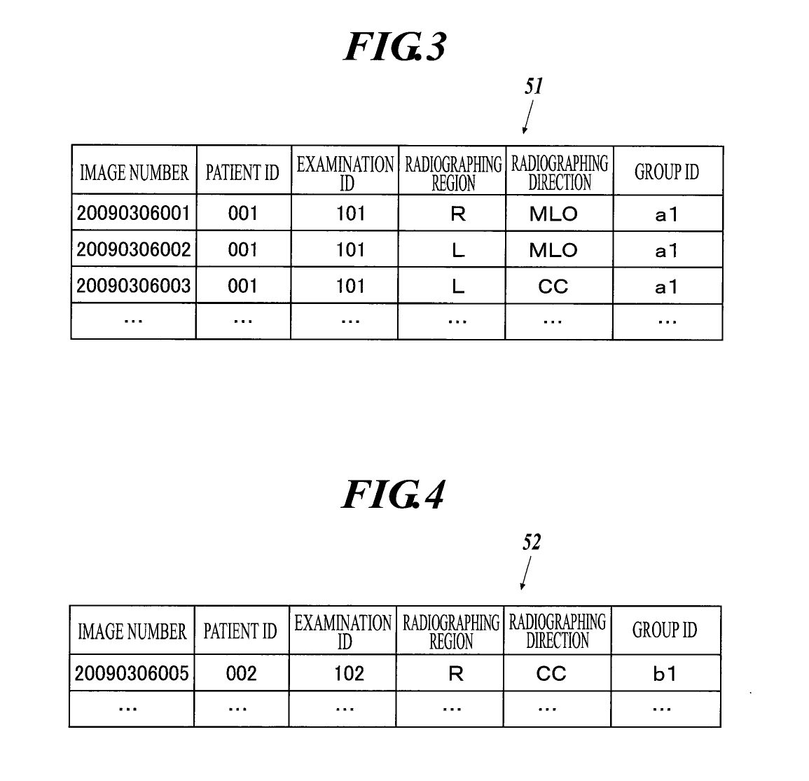

FIGS. 3 and 4 show examples of the DB. The accompanying information of the medical images the grouping of which has been completed among the medical images saved in the second storage section 36 is registered in the grouping-completed DB 51 shown in FIG. 3, and the accompanying information of the medical images the grouping of which has not been completed yet is registered in the new examination DB 52 shown in FIG. 4. Whether grouping has been completed or has not been completed only causes a change of the registration destination of accompanying information between the grouping-completed DB 51 and the new examination DB 52, and the registration contents of the accompanying information of the grouping-completed DB 51 and the new examination DB 52 are the same.

As shown in FIGS. 3 and 4, accompanying information of the image number, the patient ID, the examination ID, the radiographing region, and the radiographing direction of each of the medical images saved in the second storage section 36 are registered in the grouping-completed DB 51 and the new examination DB 52. Incidentally, R and L in the radiographing regions in FIGS. 3 and 4 indicate a left breast and a right breast, respectively. MLO and CC of the radiographing directions indicate an oblique direction and a front direction, respectively.

Moreover, the group IDs of the groups of the classified saved medical images are registered in the grouping-completed DB 51 and the new examination DB 52. For example, as shown in FIG. 3, the grouping-completed DB 51 shows that the three images of the image numbers 20090306001-2009030603 are classified into the same group of the group ID “a1.”

The lesion candidate detecting section 37 is a lesion candidate detecting means for performing the image analysis of a medical image to detect the region of a lesion candidate from the medical image. The method of the detection processing of the lesion candidate is not especially limited, and a method according to the features of the lesion region of a detection object may be used. For example, as the methods for detecting a candidate region of a growth as a lesion region, there is a technique using a Laplacian filter (The Institute of Electronics, Information and Communication Engineers (IEICE) Transactions (D-II), Vol. J76-D-II, no. 2, pp 241-249, 1993) besides the technique using an iris filter which technique is disclosed in Japanese Patent Application Laid-Open Publication No. Hei 10-91758. Moreover, there is also a disclosed method for deleting false positive candidate regions by comparing the medical images of the breasts on both sides after detecting candidate regions by the aforesaid methods (Kasai et al., “Elimination of False-positive Candidates by Comparing Right and Left Mammograms in an Automated Mass Detection Algorithm,” Medical Imaging Technology, Vol. 16, No. 6, 1998). As a detection method of a microcalcification cluster, for example, a method using a morphological filter (IEICE Transactions (D-II), Vol. J71-D-II, no. 7, pp 1170-1176, 1992), a method using a Laplacian filter (IEICE Transactions (D-II), Vol. J71-D-II, no. 10, pp 1994-2001, 1998), and a method using a triple-ring filter can be cited.

As an example, the processing of detecting a legion candidate of a microcalcification cluster by using a triple-ring filter will be described.

A microcalcification cluster appears as an image of an assemblage (clustering) of minute image parts having a low density and an almost conic density variation. On the basis of such a density characteristic, the lesion candidate detecting section 37 performs filter processing to a medical image with a triple-ring filter every square fixed region. The triple-ring filter is a ring filter in which the intensity component and the direction component of a density gradient in the case where the density variation shows an ideal conic shape are set as a vector pattern. The triple-ring filter is composed of three ring filters in each of which a different vector pattern of from the periphery to the center is set. By the filter processing, an image region having density variations in a near conic shape is detected as a candidate region of a microcalcification cluster.

The lesion candidate detecting section 37 performs the aforesaid filter processing to the medical images of breasts on both sides which breasts have been radiographed in the same radiographing direction as one set, and the lesion candidate detecting section 37 compares the medical images on both the sides which medical images have been subjected to the filter processing. The lesion candidate detecting section 37 compares the regions of the left and right breasts in which regions a lesion candidate has been detected, and the lesion candidate detecting section 37 judges whether the feature quantities of the regions almost agree with each other or not. The feature quantities are, for example, a contrast, an average value of pixel values, a standard deviation, an area, and the degree of circularity. If the feature quantities obtained by the comparison of both the regions are almost the same, the lesion candidate detecting section 37 judges that the detected lesion candidate is false positive and deletes the lesion candidate from the detection results. On the other hand, if the feature quantities are not almost the same, the lesion candidate detecting section 37 judges that the detected lesion candidate is true positive, and the lesion candidate detecting section 37 outputs the lesion candidate as a detection result.

The image server 4 saves and manages medical images together with the detection results of lesion candidates obtained by the medical image processing apparatus 3. The image server 4 is, for example, incorporated in a picture archiving and communication system (PACS) and distributes medical images and detection results of lesion candidates to a terminal for interpretation (not shown).

Next, the operation of the medical image processing apparatus 3 will be described.

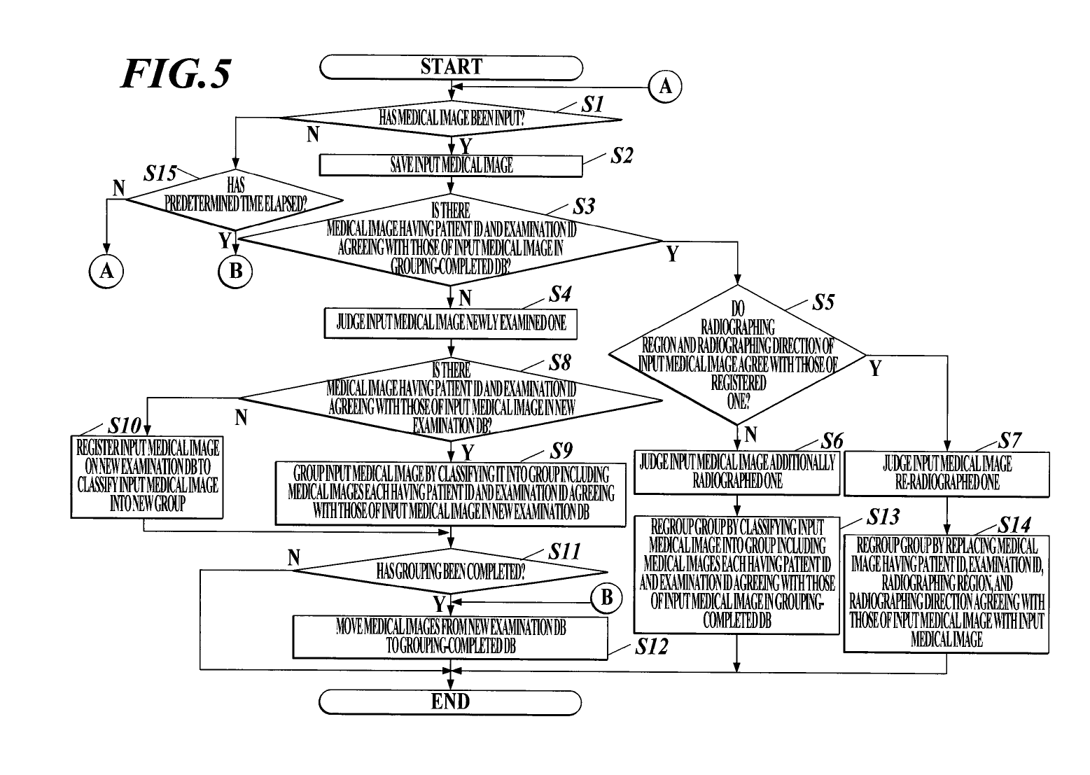

With reference to FIG. 5, the grouping processing to be executed by the medical image processing apparatus 3 will be described. The grouping processing is the processing of grouping the medical images of the objects of detection processing of lesion candidates every same examination of the same patient.

As shown in FIG. 5, when a medical image is input from the console 23 or the radiographing apparatus 21 into the medical image processing apparatus 3 (Step S1: Y), the control section 31 saves the input medical image into the second storage section 36 (Step S2). Next, the control section 31 searches the grouping-completed DB 51 to judge whether there is a medical image the grouping of which has been completed and which has a patient ID and an examination ID that agree with those of the input medical image, respectively, or not (Step S3).

If the same patient ID and the same examination ID as those of the input medical image, respectively, are not registered in the grouping-completed DB 51 and no medical image having the patient ID and the examination ID that agree with those of the input medical image, respectively, exist in the medical images the grouping of which has been completed (Step S3: N), then the control section 31 judges that the input medical image is that of a new examination (Step S4). On the other hand, if the same patient ID and the same examination ID as those of the input medical image, respectively, are registered in the grouping-completed DE 51 and there is a medical image having the patient ID and the examination ID that agree with those of the input medical image, respectively, in the medical images the grouping of which has been completed (Step S3: Y), then the control section 31 judges whether the radiographing region and the radiographing direction of the medical image agree with those of the input medical image, respectively, or not on the basis of the grouping-completed DB 51 (Step S5).

If it is judged that the radiographing regions and the radiographing directions do not agree, respectively, (Step S5: N), the control section 31 judges that the input medical image is an additionally radiographed image (Step S6). If it is judged that the radiographing regions and the radiographing directions agree, respectively, (Step S5: Y), the control section 31 judges that the input medical image is a re-radiographed medical image (Step S7).

First, the case where the newly input medical image has judged as that of a new examination will be described.

If the newly input medical image has been judged as that of a new examination, the control section 31 searches the new examination DB 52 to judge whether there is a medical image the grouping of which has not been completed yet and which has the accompanying information of a patient ID and an examination ID that agree with those of the input medical image, respectively, or not (Step S8). If the same patient ID and the same examination ID as those of the input medical image, respectively, are registered in the new examination DB 52 and there is a medical image having the patient ID and the examination ID that agree with those of the input medical image, respectively, (Step S8: Y), then the control section 31 registers the accompanying information of the input medical image, such as the image number thereof and the patient ID, in the new examination DB 52. Moreover, the control section 31 registers the same group ID as that of the medical image having the accompanying information of the patient ID and the examination ID that agree with those of the input medical image, respectively, in the new examination DB 52 as the group ID of the input medical image. Thereby, the input medical image is classified into the same group as that of the medical image having the patient ID and the examination ID that agree with those of the input medical image, respectively, in the new examination DB 52, and the input medical image is grouped (Step S9).

If the same patient ID and the same examination ID as those of the input medical image, respectively, are not registered in the new examination DB 52 and no medical image having the patient ID and the examination ID that agree with those of the input medical image, respectively, exists (Step S8: N), then the control section 31 registers the accompanying information of the input medical image in the new examination DB 52 and classifies the input medical image into a new group by adding a new group ID to the new group (Step S10).

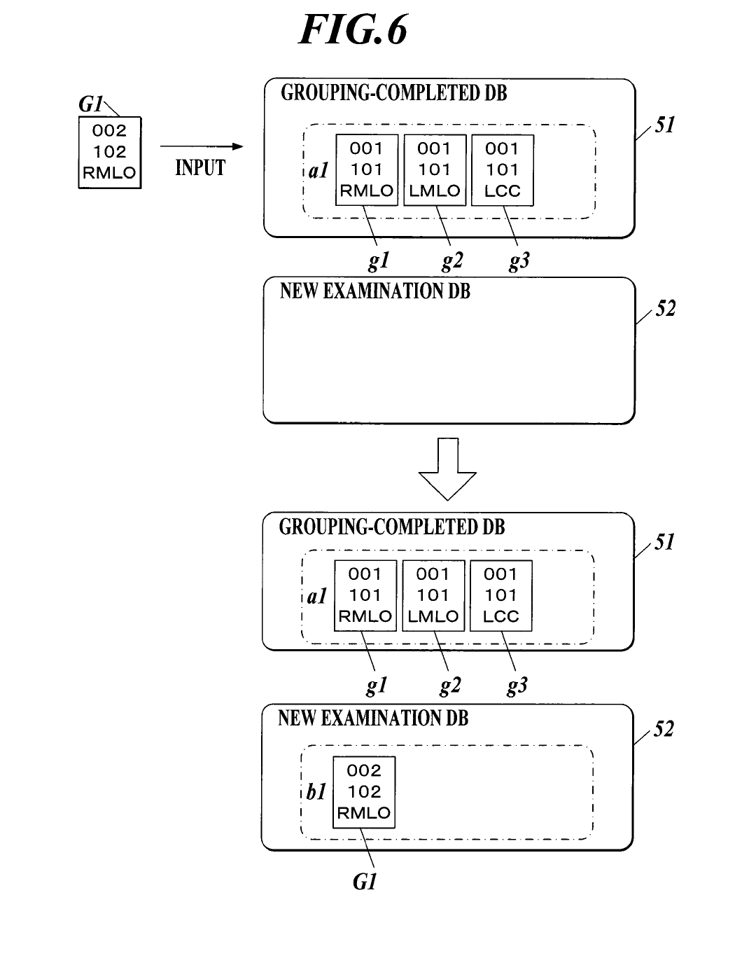

FIG. 6 shows a concrete example of the grouping when the input medical image is judged as that of a new examination.

As shown in FIG. 6, a medical image g1 (radiographing region: R, radiographing direction: MLO), a medical image g2 (radiographing region: L, radiographing direction: MLO), and a medical image g3 (radiographing region: L, radiographing direction: CC), each having a patient ID of 001 and an examination ID of 101, are classified into one group (group ID: a1) and are registered in the grouping-completed DB 51. No medical images are registered in the new examination DB 52. It is supposed that a medical image G1 (patient ID: 002, examination ID: 102, radiographing region: R, radiographing direction: CC) is newly input in this state. The patient IDs and the examination IDs of the input medical image G1 and the medical images g1, g2, and g3, the grouping of which has been completed, do not agree with each other. Also in the new examination DB 52, no medical images, each having the patient ID and the examination ID agreeing with those of the input medical image G1, respectively, are registered. Therefore, the input medical image G1 is classified into a new group (group ID: b1) and registered in the new examination DB 52.

After that, if a medical image having a patient ID of 002 and an examination ID of 102 is newly input, the patient ID and the examination ID of the medical image agree with those of the medical image G1, respectively, and the newly input medical image is accordingly classified into the group indicated by the same group ID b1 as that of the medical image G1 to be registered in the new examination DB 52.

When the input medical image has been registered in the new examination DB 52, the control section 31 judges whether or not there is a medical image of a new examination the grouping of which has been completed (Step S11). For example, if a medical image having a patient ID different from those of the medical images that have already registered in the new examination DB 52 is input to be newly registered in the new examination DB 52, the control section 31 judges that the grouping of the group of the medical images that have already been registered has been completed. Similar judgment may be performed on the basis of the examination ID and a receipt number in place of the patient ID. Alternatively, a table showing a schedule of the numbers of medical images of each patient ID and each examination ID to be input may be provided in advance, and the control section 31 may judge the completion of grouping when the numbers of medical images indicated in the table have been grouped and registered in the new examination DB 52.

If there is no new examination in which the grouping has been completed (Step S11: N), the control section 31 ends the present processing. On the other hand, if there is a new examination in which the grouping has been completed (Step S11: Y), the control section 31 moves the registered information of the medical images belonging to the group, in which the grouping has been completed, from the new examination DB 52 to the grouping-completed DB 51 (Step S12) and ends the present processing. After that, if there is a newly input medical image, the control section 31 starts the processing from that at Step S1.

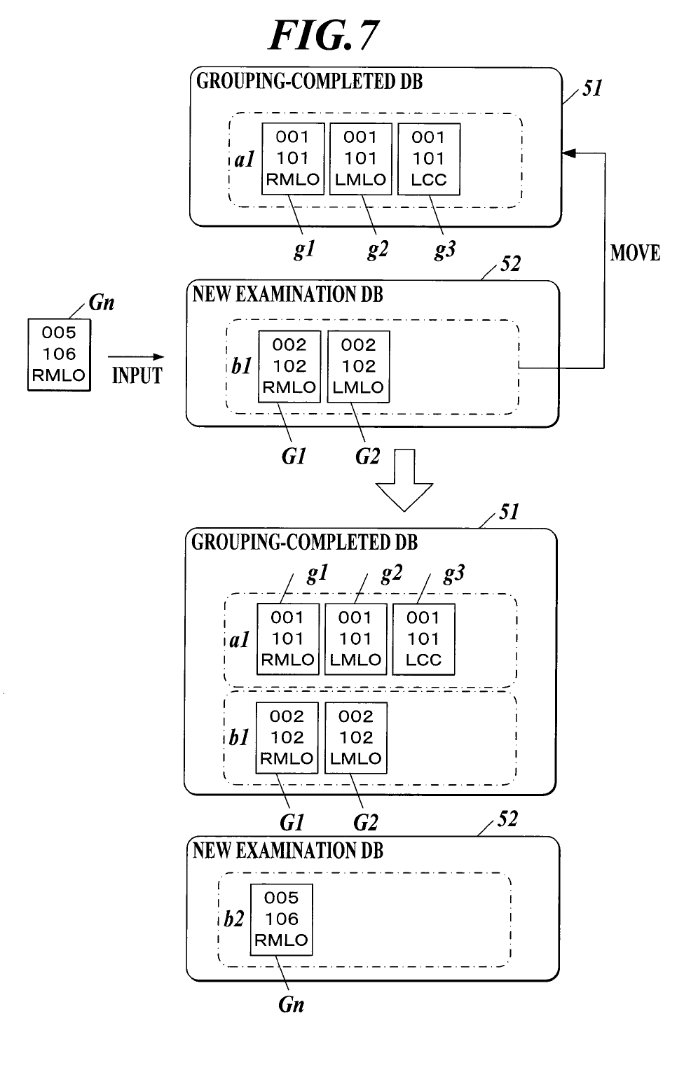

FIG. 7 shows a concrete example of the new examinations where the grouping has been completed.

As shown in FIG. 7, the medical images G1 and G2, each having a patient ID of 002 and an examination ID of 102, are classified into one group (group ID: b1) and are registered in the new examination DB 52. It is supposed that a medical image Gn (patient ID: 005, examination ID: 106, radiographing region: R, radiographing direction MLO) is newly input in this state. The patient ID and the examination ID of the input medical image Gn do not agree with any of those of the medical images g1-g3, registered in the grouping-completed DB 51, and the medical images G1 and G2, registered in the new examination DB 52, respectively. The input medical image Gn is accordingly classified into a new group (group ID: b2) and is registered in the new examination DB 52. At this time, the medical image Gn of the patient ID different from those of the already registered medical images G1 and G2 has been registered in the new examination DB 52, and the control section 31 accordingly judges that the grouping of the medical images G1 and G2 has been completed to move their registered information into the grouping-completed DB 51 as shown in FIG. 7.

Next, the case where a newly input medical image is judged as that of additional radiography will be described.

If it is judged that an input medical image is that of additional radiography, the control section 31 registers the accompanying information of the input medical image in the grouping-completed DB 51 and registers the same group ID as those of the medical images of the patient ID and the examination ID that agree with those of the input medical image, respectively, in the grouping-completed DB 51. The input medical image is thereby classified into the group of the medical images the grouping of which has been completed and which have the patient IDs and the examination IDs agreeing with those of the input medical image, respectively, and regrouping is performed (Step S13). After the regrouping, the control section 31 ends the present processing. If there is a newly input medical image, the control section 31 starts the processing from that at Step S1.

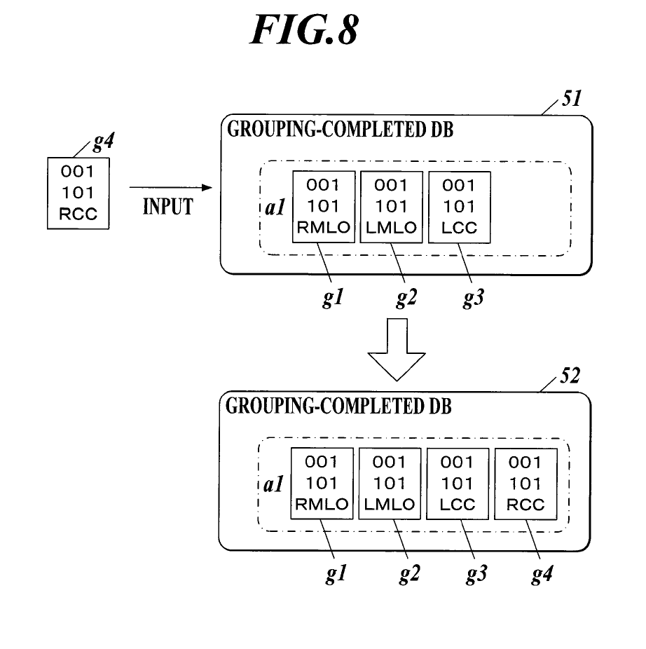

FIG. 8 shows a concrete example of the case where a newly input medical image is judged as that of additional radiography.

As shown in FIG. 8, the medical image g1 (radiographing region: R, radiographing direction: MLO), the medical image g2 (radiographing region: L, radiographing direction: MLO), the medical image g3 (radiographing region: L, radiographing direction: CC), each having a patient ID of 001 and an examination ID of 101, are classified into one group (group ID: a1) to be resisted in the grouping-completed DB 51. It is supposed that a medical image g4 (patient ID: 001, examination ID: 101, radiographing region: R, radiographing direction CC) is newly input in this state. The patient ID and the examination ID of the input medical image g4 agree with those of the medical images g1, g2, and g3, the grouping of which has been completed, respectively, but the radiographing region and the radiographing direction of the input medical image g4 do not agree with those of the medical images g1, g2, and g3. The same group ID a1 as those of the medical image g1-g3 is accordingly given to the input medical image g4, and the input medical image g4 is registered in the grouping-completed DB 51. The group of the group ID a1 is thereby regrouped.

Next, the case where a newly input medical image is judged as that of re-radiography will be described.

If the newly input medical image is judged that of re-radiography, the control section 31 registers the accompanying information of the input medical image in the grouping-completed DB 51 and registers the same group ID as those of the medical image having the patient ID, the examination ID, the radiographing region, and the radiographing direction that agree with those of the input medical image, respectively, in the grouping-completed DB 51. Next, the control section 31 deletes the accompanying information of the medical image having the patient ID, the examination ID, the radiographing region, and the radiographing direction that agree with those of the input medical image, respectively, from the grouping-completed DB 51. The medical image having the patient ID, the examination ID, the radiographing region, and the radiographing direction that agree with those of the input medical image, respectively, is thereby replaced with the input medical image, and regrouping is performed (Step S14). After the regrouping, the control section 31 ends the present processing. If there is a newly input medical image, the control section starts the processing from that at Step S1.

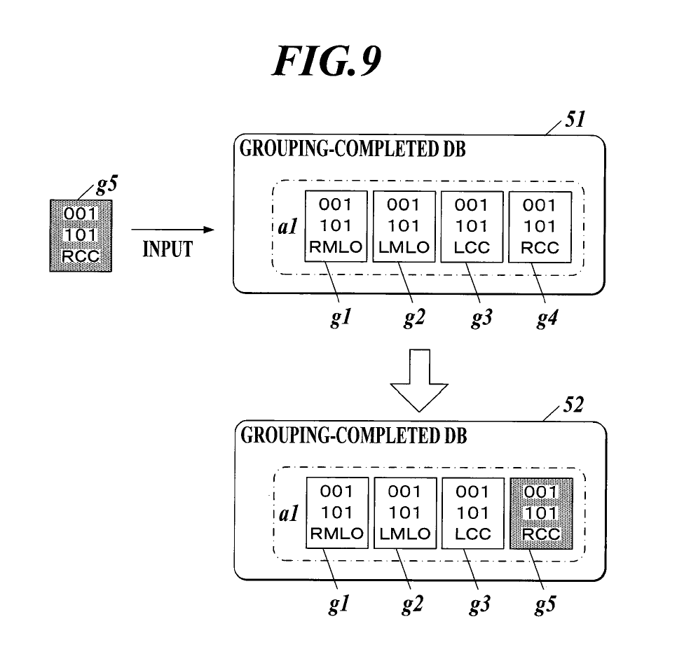

FIG. 9 shows a concrete example of a case where a newly input medical image is judged as that of re-radiography.

As shown in FIG. 9, the medical image g1 (radiographing region: R, radiographing direction: MLO), the medical image g2 (radiographing region: L, radiographing direction: MLO), the medical image g3 (radiographing region: L, radiographing direction: CC), and the medical image g4 (radiographing region: R, radiographing direction: CC), each having a patient ID of 001 and an examination ID of 101, are classified into one group (group ID: a1) and are registered in the grouping-completed DB 51. It is supposed that a medical image g5 (patient ID: 001, examination ID: 101, radiographing region: R, radiographing direction CC) is newly input in this state. The patient ID, the examination ID, the radiographing region, and the radiographing direction of the input medical image g5 agree with those of the medical image g4, the grouping of which has been completed, respectively. The medical image g4 is accordingly replaced with the input medical image g5, and the input medical image g5 is registered in the grouping-completed DB 51. The regrouping of the group of the group ID a1 is thereby performed.

In the way mentioned above, the grouping of the medical images input into the medical image processing apparatus 3 is performed, but the control section 31 closes the reception of a medical image of a new examination when no new medical images are input while a predetermined time has elapsed (Step S1: N, Step S15: Y). The control section 31 then judges that the grouping of the medical images that are presently registered in the new examination DB 52 has been completed, and the control section 31 moves the registered information of the medical images belonging to the groups the grouping of which has been completed from the new examination DB 52 to the grouping-completed DB 51 (Step S12) to end the present processing. After that, if there is a newly input medical image, the control section 31 starts the processing from that at Step S1.

After the grouping processing mentioned above, the control section 31 outputs the medical images saved in the second storage section 36 to the lesion candidate detecting section 37. At this time, the control section 31 refers to the group IDs in the grouping-completed DB 51 and reads out the medical images belonging to the same groups, that is, the medical images of the same patients and the same examinations, from the second storage section 36 to output the read medical images to the lesion candidate detecting section 37 by the group. The lesion candidate detecting section 37 uses the medical images by the group for the detection processing of lesion candidates.

Even after once executing the detection processing of the lesion candidates, if a medical image has been judged to that of additional radiography or re-radiography by the aforesaid grouping processing and regrouping has been performed, the control section 31 outputs the regrouped medical images to the lesion candidate detecting section 37 by the group. The lesion candidate detecting section 37 executes the detection processing of lesion candidates again for the regrouped medical images as objects.

As described above, according to the present embodiment, the control section 31 collates the accompanying information of the medical images which are registered in the grouping-completed DB 51 and the grouping of which images has been completed with the accompanying information of the patient ID and the examination ID of an input medical image and judges that the input medical image is that of a new examination when the pieces of accompanying information are not agree with each other. When the input medical image is judged that of a new examination, the control section 31 collates the accompanying information of the medical images registered in the new examination DB 52 with the accompanying information of the patient ID and the examination ID of the input medical image. If the pieces of accompanying information agree with each other, the control section 31 classifies the input medical image into the group of the medical images having the agreeing accompanying information. If the pieces of accompanying information do not agree with each other, the control section 31 classifies the input medical image into a new group to group the input medical image.

Medical images that have radiographed and have been input according to schedule can thereby be grouped every same examination of the same patient.

Moreover, if the accompanying information of the patient IDs and the examination IDs agrees with each other, respectively, and if the accompanying information of the radiographing regions and the radiographing directions does not agree with each other, respectively, between the medical images the grouping of which has been completed and an input medical image, then the control section 31 judges that the input medical image is that of re-radiography. In this case, the control section 31 classifies the input medical image into a group of the medical images the grouping of which has been completed and which have the agreeing patient IDs and examination IDs, respectively, and the control section 31 regroups the group.

On the other hand, if the accompanying information of the patient IDs and the examination IDs agree with each other, respectively, and if the accompanying information of the radiographing regions and the radiographing directions also agree with each other, respectively, between the medical images the grouping of which has been completed and the input medical image, then the control section 31 judges that the input medical image is that of re-radiography. In this case, the control section 31 classifies the input medical image into the group of the medical image the grouping of which has been completed and which has the patient ID, the examination ID, the radiographing region, and the radiographing direction that agree with those of the input medical image, respectively, to regroups the group.

Thereby, even if an unscheduled medical image is input by additional radiography or re-radiography, the medical images the grouping of which has already been completed and the input medical image can collectively be regrouped, and the medical images can correctly be grouped every same examination of the same patient. If a medical image has not been input in a predetermined time owing to a network trouble or the like even if examination radiography has been performed according to schedule, the medical image is sometimes regarded as that of a new examination and is not grouped in the group of the same patient and the same examination. However, according to the present embodiment, also the medical image input behind on schedule is collectively regrouped with the medical images the grouping of which has already completed although the input medical image is treated as that of additional radiography, and consequently the medical images can correctly be grouped every same examination of the same patient.

The regrouped medical images are output to the lesion candidate detecting section 37 by the group and are reprocessed, and consequently the breasts on both sides can be compared with each other at the time of detecting a lesion candidate to improve the accuracy of the detection processing of the lesion candidate.

The embodiment described above is a suitable example of the present invention, and the present invention is not limited to this embodiment.

For example, although the medical image processing apparatus 3 performs grouping processing in the embodiment described above, the grouping processing may be performed by the console 23 or the image server 4. If the grouping processing is performed by the console 23, the console 23 groups the medical images generated by the radiographing apparatus 21 or the reading apparatus 22 and transmits the medical images to the medical image processing apparatus 3 by the group as the objects of the detection processing of a lesion candidate by the lesion candidate detecting section 37. If the grouping processing is performed by the image server 4, the image server 4 groups the medical images input from the console 23 and similarly transmits the medical images to the medical image processing apparatus 3 by the group. If regrouping is caused by additional radiography or re-radiography in either case, even the medical images that have once been transmitted may be transmitted again by the regrouped group. The lesion candidate detecting section 37 of the medical image processing apparatus 3 executes the detection processing of a lesion candidate by using the medical images transmitted by the group.

Moreover, although the example of the radiography system 2 to which only the radiographing apparatus 21 dedicated for mammography is connected has been shown in the embodiment described above, a radiography system to which another radiographing apparatus such as an MRI is connected may be adopted. In this case, the control section 31 may refer to the accompanying information of an input medical image before grouping processing and may perform the grouping processing of only the medical images the kind of the radiographing apparatus of which is mammography.

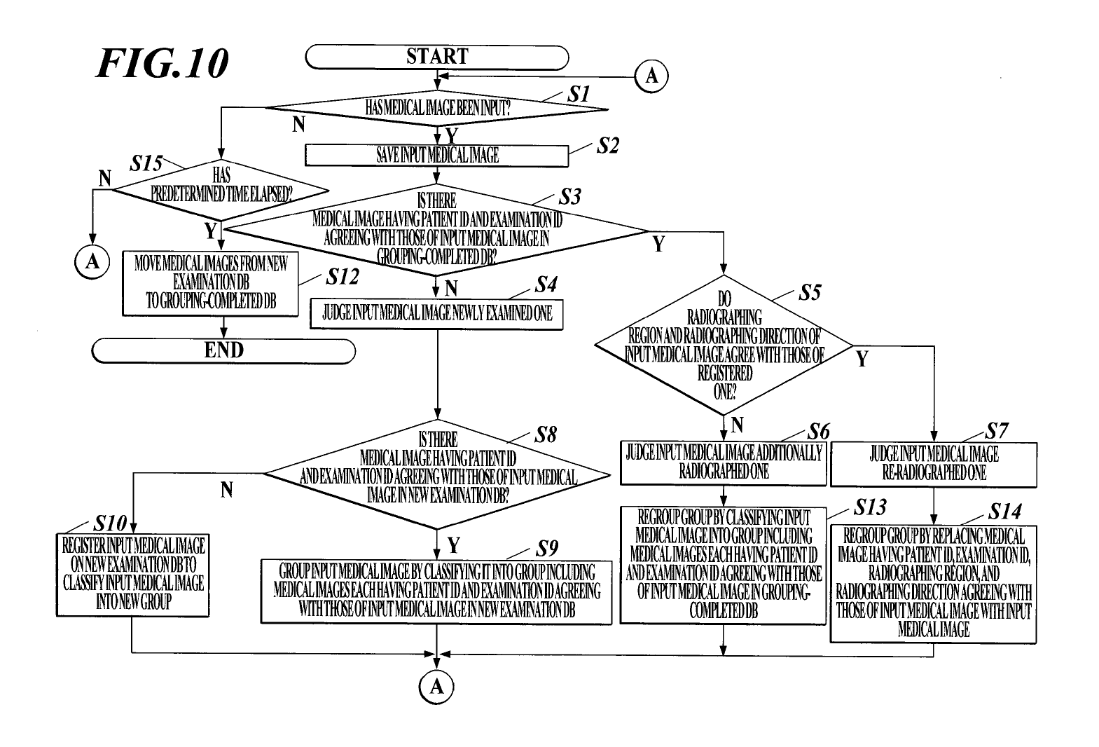

Moreover, the grouping processing shown in FIG. 10 may be executed in place of the grouping processing shown in FIG. 5. In FIG. 10, processing parts of the same content as that of the processing parts of the processing shown in FIG. 5 are denoted by the same step numbers as those of the processing shown in FIG. 5.

In the grouping processing shown in FIG. 10, after judging which of a medical image of a new examination, additional radiography, and re-radiography an input medical image is and performing the grouping or the regrouping thereof (Step S9, S13, and S14), the control section 31 returns the present processing to that at Step S1. If there is no newly input medical image even after a predetermined time has elapsed (Step S1: N, Step S15: Y), the control section 31 moves the registered information of medical images from the new examination DB 52 to the grouping-completed DB 51 (Step S12) and ends the present processing. That is, in the grouping processing shown in FIG. 10, even if an input medical image is any of the medical image of new radiography, additional radiography, or re-radiography, the control section 31 performs the grouping or the regrouping of a medical image group of the medical images of the same patient and the same examination which medical images have been input in a predetermined time.

Moreover, as a computer-readable medium of the programs according to the present invention, a nonvolatile memory, such as a ROM and a flash memory, and a portable recording medium, such as a CD-ROM, can be applied.

Moreover, as a medium for providing the data of the programs according to the present invention through communication lines, carrier waves can also be applied to the present invention.

All the disclosures of Japanese Patent Application No. 2009-091128, filed on Apr. 3, 2009, including the description, the claims, the accompanying drawings, and the summary thereof is incorporated in the present application as a part thereof.

### INDUSTRIAL APPLICABILITY

The present invention is usable in the medical field in which medical images are compared and interpreted.

### REFERENCE NUMERALS

1 medical image system
2 radiography system
21 radiographing apparatus
22 reading apparatus
23 console
3 medical image processing apparatus
31 control section
36 second storage section
37 lesion candidate detecting section
4 image server
51 grouping-completed DB
52 new examination DB

1. A medical image processing apparatus, comprising:
a control unit for grouping input medical images from every same examination of a same patient by using accompanying information of the input medical images, and for saving the grouped medical images in a storage unit, wherein
when a medical image is newly input, the control unit collates accompanying information of the newly input medical image with the accompanying information of the medical images, the grouping of which has already been completed, to thereby judge whether the newly input medical image has been obtained by either additional radiography or by re-radiography, and the control unit regroups the newly input medical image and the medical images, the grouping of which has already been completed, from every same examination of the same patient, by using the accompanying information when the control unit judges that the newly input medical image has been obtained by either additional radiography or by re-radiography.

2. The medical image processing apparatus according to claim 1, wherein
when the accompanying information of the newly input medical image and the accompanying information of the medical images, the grouping of which has already been completed, agree with each other for the patient and the examination, respectively, and when the accompanying information of the newly input medical image and the accompanying information of the medical images, the grouping of which has already been completed, do not agree with each other for a radiographing region and a radiographing direction, respectively, then the control unit judges that the newly input medical image is obtained by additional radiography, and the control unit classifies the newly input medical image into a group of medical images, each of which has accompanying information agreeing with the accompanying information of the newly input medical image for the patient and the examination, respectively, the grouping of which medical images has already been completed, and thereby the control unit regroups the group.

3. The medical image processing apparatus according to claim 1, wherein
when the accompanying information of the newly input medical image and the accompanying information of one of the medical images, the grouping of which has already been completed, agree with each other for the patient, the examination, the radiographing region, and the radiographing direction, respectively, the control unit judges that the newly input medical image is obtained by re-radiography, and the control unit replaces the medical image, the grouping of which has already been completed, and which has the accompanying information agreeing with the accompanying information of the newly input medical image for the patient, the examination, the radiographing region, and the radiographing direction, and the control unit regroups the group.

4. The medical image processing apparatus according to claim 1, wherein
when the medical images are regrouped, the control unit outputs the regrouped medical images to a lesion candidate detecting unit by the group.

5. A grouping method of input medical images by means of a medical image processing apparatus, the method comprising the steps of:
grouping the input medical images from every same examination of a same patient to save the grouped medical images in a storage unit by using accompanying information of the input medical images with a control unit;
collating accompanying information of a newly input medical image with the accompanying information of the medical images, the grouping of which has already been completed, to thereby judge whether the newly input medical image has been obtained by either additional radiography or by re-radiography with the control unit when the medical image is newly input; and
regrouping the newly input medical image and the medical images, the grouping of which has already been completed, from every same examination of the same patient by using the accompanying information when it is judged that the newly input medical image has been obtained by either additional radiography or by re-radiography with the control unit.

6. A computer readable medium embodying a program for making a computer function as a control unit for
grouping input medical images from every same examination of a same patient by using accompanying information of the input medical images to save the grouped medical images in a storage unit;
collating accompanying information of a newly input medical image with the accompanying information of the medical images, the grouping of which has already been completed, to thereby judge whether the newly input medical image has been obtained by either additional radiography or by re-radiography when the medical image is newly input; and
regrouping the newly input medical image and the medical images, the grouping of which has already been completed, every same examination of the same patient by using the accompanying information when it is judged that the newly input medical image has been obtained by either additional radiography or by re-radiography.

7. The medical image processing apparatus according to claim 2, wherein when the accompanying information of the newly input medical image and the accompanying information of one of the medical images, the grouping of which has already been completed, agree with each other for the patient, the examination, the radiographing region, and the radiographing direction, respectively, the control unit judges that the newly input medical image is obtained by re-radiography, and the control unit replaces the medical image, the grouping of which has already been completed, and which has the accompanying information agreeing with the accompanying information of the newly input medical image for the patient, the examination, the radiographing region, and the radiographing direction, and the control unit regroups the group.

8. The medical image processing apparatus according to claim 7, wherein
when the medical images are regrouped, the control unit outputs the regrouped medical images to a lesion candidate detecting unit by the group.

9. The medical image processing apparatus according to claim 2, wherein
when the medical images are regrouped, the control unit outputs the regrouped medical images to a lesion candidate detecting unit by the group.

10. The medical image processing apparatus according to claim 3, wherein
when the medical images are regrouped, the control unit outputs the regrouped medical images to a lesion candidate detecting unit by the group.
